(19) United States
(12) Patent Application Publication
(10) Pub. No.: US 2010/0040251 A1
(43) Pub. Date: Feb. 18, 2010

(54) HANG UP MAGNET FOR RADIO MICROPHONE

(76) Inventor: Bryan Schreiber, Knoxville, TN (US)

Correspondence Address: LUEDEKA, NEELY & GRAHAM, P.C., P O BOX 1871, KNOXVILLE, TN, 37901, US

(21) Appl. No.: 12/542,145

(22) Filed: Aug. 17, 2009

Related U.S. Application Data
(60) Provisional application No. 61/089,071, filed on Aug. 15, 2008.

(51) Int. Cl. H04R 11/04

(52) U.S. Cl. 381/368; 381/361

(57) ABSTRACT

A system is disclosed for safely and efficiently removing or returning a radio microphone from a mounting surface. The system includes a first magnet attached to the rear side of a radio microphone and a second magnet located at a desired mounting position on the mounting surface. The second magnet preferably includes an outer vinyl layer to prevent breaking or cracking of the first second magnet when returning the radio microphone to its mounting position.

This application claims priority to provisional application No. 61/089,071 filed Aug. 15, 2008 titled Hang Up Magnet for Radio Microphone.

### FIELD

This invention relates to the field of radio microphone devices. More particularly, this invention relates to a system for safely and efficiently removing or returning a radio microphone from its mounting device using magnets.

### BACKGROUND

Radio microphones have traditionally been attached to their mounting device in an automobile using a clip assembly. The clip assembly utilizes a tongue and groove attachment. As such, when the radio user wants to remove or replace a radio microphone from the traditional ‘hang-up clip’ mount, they might find it difficult to locate the precise positioning required to attach the radio microphone to its mounting device. This normally requires them to either waste time trying to remove or replace the microphone or causing them to concentrate on removing or replacing the microphone rather than concentrating on their driving.

What is needed, therefore, is a system for safely and efficiently removing or returning a radio microphone from its mounting device.

### SUMMARY

Embodiments of the invention described herein pertain to a magnetized radio microphone mounting system. According to one embodiment of the invention the radio microphone mounting system includes a radio microphone having a rear surface. A magnet is externally attached to the rear surface of the radio microphone for mounting the radio microphone to a magnetically attractable mounting surface. In preferred embodiments, the mounting system includes a second magnet for attaching to the mounting surface and for attracting the magnet attached to the rear surface of the radio microphone, the attraction between the magnets being of sufficient strength for the mounting of the radio microphone to the mounting surface. An external shock absorbent layer may be provided for covering at least one of the magnets for preventing damage to the magnets and the mounting surface. In preferred embodiments, the external shock absorbent layer is vinyl.

According to another embodiment of the invention, the second magnet is disposed within an outer layer of a plastic housing. The plastic housing includes at least one hole for attaching the plastic housing to the mounting surface, and the hole may be elongated for adjusting the height of the plastic housing with respect to the mounting surface. In other embodiments, the magnet attached to the rear surface of the radio microphone may be disposed within a plastic housing.

According to another embodiment of the invention, the radio microphone mounting system includes a first magnet for attaching to a rear surface of a radio microphone and a second magnet for attaching to a mounting surface, the second magnet for attracting the first magnet and the attraction between the first and second magnets being of sufficient strength for the mounting of the radio microphone to the mounting surface. An external shock absorbent layer may be provided for covering at least one of the magnets for preventing damage to the magnets and the mounting surface. In preferred embodiments, the external shock absorbent layer is vinyl.

According to another embodiment of the invention, the radio microphone mounting system includes a radio microphone having a non-magnetic rear surface receptive to magnetic flux and a magnet for attaching to a mounting surface, the magnet for attracting the non-magnetic rear surface of the radio microphone and for mounting the radio microphone to the mounting surface. In preferred embodiments, the non-magnetic rear surface is a metallic material receptive to magnetic flux.

### BRIEF DESCRIPTION OF THE DRAWINGS

Further advantages of the invention are apparent by reference to the detailed description in conjunction with the figures.

FIG. 1 depicts a traditional hang-up clip assembly for mounting a traditional radio microphone as commonly known in the prior art;

FIG. 2 depicts a tongue assembly attached to the rear end of a radio microphone for mounting upon the traditional hang-up clip assembly of FIG. 1 as commonly known in the prior art;

FIG. 3 depicts a magnet attached to the rear surface of a radio microphone according to an embodiment of the invention;

FIG. 4 depicts a magnet attached to the rear surface of the radio microphone and mounted to a second magnet attached to a mounting surface according to an embodiment of the present invention;

FIG. 5 depicts a plastic housing for mounting second magnet to the microphone mounting surface; and

FIG. 6 is a right side view of the plastic housing depicted in FIG. 5.

### DETAILED DESCRIPTION

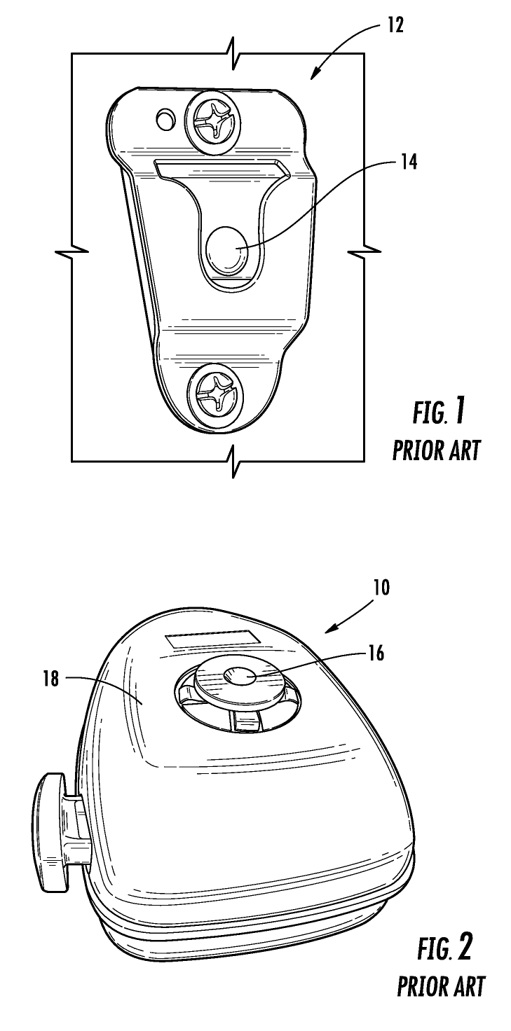

Shown in FIGS. 1 and 2 is a device well known in the art for attaching a radio microphone 10 to an automobile dashboard or other mounting location using a traditional hang-up clip assembly 12. Referring to FIG. 1, the traditional hang-up clip assembly 12 utilizes a metal groove 14 for mounting the radio microphone 10 when the microphone is not being used. As depicted in FIG. 2, a metal tongue 16 is attached to the rear side 18 of the radio microphone 10 for placement in the metal groove 14 when hanging up the radio microphone 10.

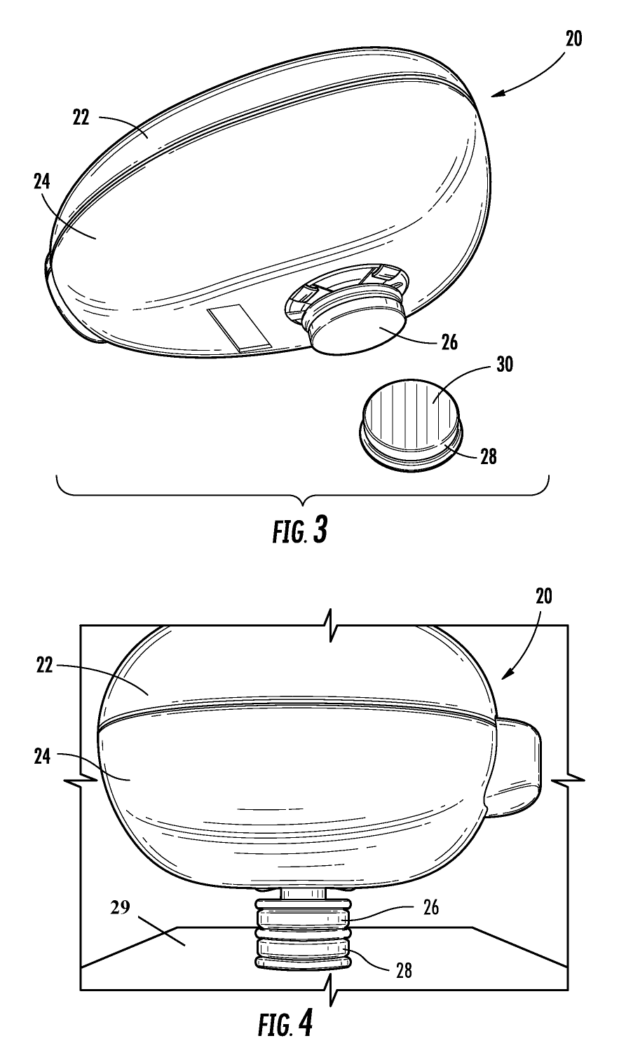

A radio microphone 20 according to one embodiment of the present invention is depicted in FIGS. 3 and 4. The radio microphone 20 has a front side 22 and rear side 24, and a first magnet 26 is externally attached to the rear side 24 of the radio microphone 20. The first magnet 26 is of a sufficient strength to attach to a second magnet 28 disposed at a desired location 29, such as the dashboard of an automobile, for mounting the radio microphone 20. Due to the attraction between the first 26 and second magnets 28, a user of the microphone 20 preferably only has to place the rear side 24 of the microphone 20 in the general vicinity of the second magnet 28 for the mounting of the radio microphone 20 to the mounting surface 29. Thus, the user can quickly and efficiently mount the radio microphone 20 after use without taking his eyes off the road, or otherwise diverting his attention from driving, to accurately place the microphone 20 in the traditional clip assembly 12. Furthermore, the user will be able to easily remove the microphone 20 from its mounted location for use by merely pulling on the microphone 20 with enough strength to separate the first 26 and second magnets 28.

The second magnet 28 disposed at the mounting surface 29 may also include an outer vinyl layer 30. The outer vinyl layer 30 acts as a cushion or shock absorber that allows the user to hang up the radio microphone 20 without fear of cracking or breaking either of the first 26 or second magnets 28 when they are pulled together. Alternatively, the first magnet 26, or both the first 26 and second magnets 28, may include an outer vinyl layer 30.

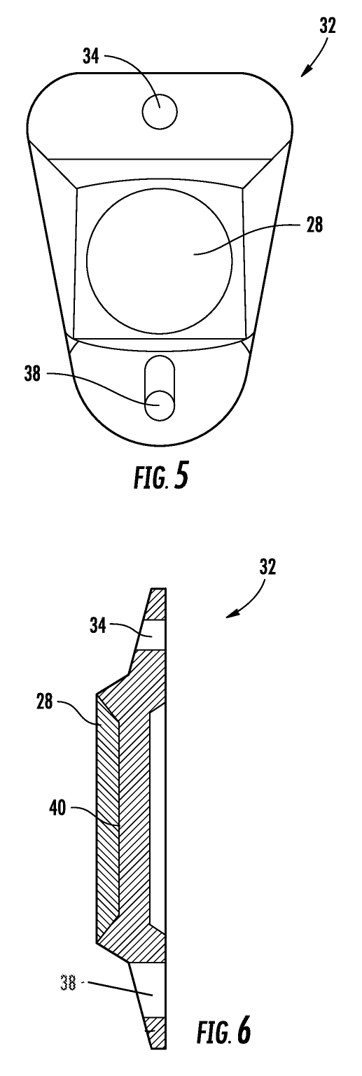

According to another embodiment of the invention, the second magnet 28 may be disposed within a plastic housing 32, and the plastic housing can be attached to the desired mounting surface 29. As shown in FIGS. 5 and 6, the plastic housing 32 may include an upper hole 34 and a lower hole 38 for attaching the plastic housing 32 to the desired mounting surface 29 using screws or other attachment means. The mounting surface 29 may include, for example, the dashboard of a vehicle, a desk, or any other mounting location where radio microphones may be used. Thus, the user may attach the plastic housing 32 and associated second magnet 28 to any desired mounting surface 29, and the plastic housing 32 may be removed and utilized with a different radio microphone 20 and/or another mounting location. The upper hole 34 and/or lower hole 32 may also be elongated to allow for adjustment of the plastic housing 32 in an upward or downward direction when attaching the housing 32 to the mounting surface 29. As shown in FIG. 6, the second magnet 28 is preferably embedded within the outer surface 40 of the plastic housing 32 so that the attraction of the second magnet 28 is not diminished. Furthermore, the plastic housing 32 and/or second magnet 28 may also include the outer vinyl layer 30 to prevent breaking of the magnets 26 and 28 as described above.

While the plastic housing 32 is discussed above with respect to the second magnet 28, a similar plastic housing as described above may also be used to attach the first magnet 26 to the radio microphone 20.

In an alternative embodiment of the present invention, the radio microphone 20 does not include the first magnet 26. Instead of the first magnet 26, the rear side 24 of the radio microphone 20 has a metal body for attraction to the second magnet 28. Thus, a user only has to place the metal body of the radio microphone 20 near the second magnet 28 to replace the radio microphone 20 at the mounting location.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention.

What is claimed is:

1. A radio microphone mounting system comprising:
a radio microphone having a rear surface; and
a magnet externally attached to the rear surface of the radio microphone for mounting the radio microphone to a magnetically attractable mounting surface.

2. The radio microphone mounting system of claim 1 further comprising:
a second magnet for attaching to the mounting surface and for attracting the magnet attached to rear surface of the radio microphone, the attraction between the magnets being of sufficient strength for the mounting of the radio microphone to the mounting surface; and
an external shock absorbent layer at least partially covering at least one of the magnets for preventing damage to the magnets and the mounting surface, wherein the external shock absorbent layer is comprised of vinyl.

3. The radio microphone mounting system according to claim 1 wherein the magnet is at least partially covered by an external shock absorbent layer for preventing damage to the magnet and the mounting surface.

4. The radio microphone mounting system according to claim 3 wherein the external shock absorbent layer is comprised of vinyl.

5. The radio microphone mounting system according to claim 1 further comprising a second magnet for attaching to the mounting surface and for the mounting of the radio microphone to the mounting surface.

6. The radio microphone mounting system according to claim 5 wherein the second magnet is disposed within an outer layer of a plastic housing.

7. The radio microphone mounting system according to claim 6 wherein the plastic housing includes at least one hole for attaching the plastic housing to the mounting surface, the hole being elongated for adjusting the height of the plastic housing with respect to the mounting surface.

8. The radio microphone mounting system according to claim 5 wherein the second magnet is at least partially covered by an external shock absorbent layer for preventing damage to the magnets and the mounting surface.

9. The radio microphone mounting system according to claim 8 wherein the external shock absorbent layer is comprised of vinyl.

10. A radio microphone mounting system comprising:
a radio microphone having a non-magnetic rear surface receptive to magnetic flux; and
a magnet for attaching to a mounting surface, the magnet for attracting the non-magnetic rear surface of the radio microphone and for mounting the radio microphone to the mounting surface.

11. The radio microphone mounting system of claim 10 wherein the non-magnetic rear surface is comprised of a metallic material receptive to magnetic flux.

12. The radio microphone mounting system according to claim 10 wherein the magnet is at least partially covered by an external shock absorbent layer for preventing damage to the magnet and the mounting surface.

13. The radio microphone mounting system according to claim 12 wherein the external shock absorbent layer is comprised of vinyl.

14. The radio microphone mounting system according to claim 10 wherein the magnet is disposed within a plastic housing, the plastic housing including at least one hole for attaching the plastic housing to the mounting surface, the hole being elongated for adjusting the height of the plastic housing with respect to the mounting surface.

15. A radio microphone mounting system comprising:
a first magnet for attaching to a rear surface of a radio microphone; and
a second magnet for attaching to a mounting surface, the second magnet for attracting the first magnet attached to the rear surface of the radio microphone, the attraction between the first and second magnets being of sufficient strength for the mounting of the radio microphone to the mounting surface.

16. The radio microphone mounting system according to claim 15 wherein at least one of the first and second magnets is covered by an external shock absorbent layer for preventing damage to the magnets and the mounting surface.

17. The radio microphone mounting system according to claim 16 wherein the external shock absorbent layer is comprised of vinyl.

18. The radio microphone mounting system according to claim 15 wherein the first magnet is disposed within an outer layer of a plastic housing.

19. The radio microphone mounting system according to claim 15 wherein the second magnet is disposed within an outer layer of a plastic housing.

20. The radio microphone mounting system according to claim 19 wherein the plastic housing includes at least one hole for attaching the plastic housing to the mounting surface, the hole being elongated for adjusting the height of the plastic housing with respect to the mounting surface.
